(19) United States
(12) Patent Application Publication
(10) Pub. No.: US 2014/0245908 A1
(43) Pub. Date: Sep. 4, 2014

(54) METHOD OF PRINTING INTERSECTING LINES WITH ANGLE EFFECT

(71) Applicants: Ed S. Ramakrishnan, Spring, TX (US); Daniel Van Ostrand, Conroe, TX (US); Robert J. Petcavich, The Woodlands, TX (US)

(72) Inventors: Ed S. Ramakrishnan, Spring, TX (US); Daniel Van Ostrand, Conroe, TX (US); Robert J. Petcavich, The Woodlands, TX (US)

(73) Assignee: Uni-Pixel Displays, Inc., The Woodlands, TX (US)

(21) Appl. No.: 13/784,782

(22) Filed: Mar. 4, 2013

(51) Int. Cl. B41F 5/24

(52) U.S. Cl. CPC B41F 5/24
USPC 101/23; 101/492

(57) ABSTRACT

A method of printing intersecting lines with angle effect includes transferring ink to a flexo master. The flexo master includes embossing patterns disposed at an adjusted angle relative to an x-y axis. Ink is transferred from the flexo master to a substrate.

### BACKGROUND OF THE INVENTION

An electronic device with a touch screen allows a user to control the device by touch. The user may interact directly with the objects depicted on the display through touch or gestures. Touch screens are commonly found in consumer, commercial, and industrial devices including smartphones, tablets, laptop computers, desktop computers, monitors, gaming consoles, and televisions. A touch screen includes a touch sensor that includes a pattern of conductive lines disposed on a substrate.

Flexographic printing is a rotary relief printing process that transfers an image to a substrate. A flexographic printing process may be adapted for use in the fabrication of touch sensors. In addition, a flexographic printing process may be adapted for use in the fabrication of flexible and printed electronics (“FPE”).

### BRIEF SUMMARY OF THE INVENTION

According to one aspect of one or more embodiments of the present invention, a method of printing intersecting lines with angle effect includes transferring ink to a flexo master. The flexo master includes embossing patterns disposed at an adjusted angle relative to an x-y axis. Ink is transferred from the flexo master to a substrate.

According to one aspect of one or more embodiments of the present invention, a flexographic printing system includes an ink roll, an anilox roll, a plate cylinder, a flexo master, and an impression cylinder. The flexo master is disposed on the plate cylinder. The flexo master includes embossing patterns disposed at an adjusted angle relative to an x-y axis.

Other aspects of the present invention will be apparent from the following description and claims.

### BRIEF DESCRIPTION OF THE DRAWINGS

FIG. 1 shows a side view of a flexographic printing system.

FIG. 2 shows an isometric view of a portion of a flexographic printing system.

FIG. 3 shows an isometric view of a portion of a flexographic printing system for printing intersecting lines with angle effect in accordance with one or more embodiments of the present invention.

FIG. 4 shows a connection between high-resolution printed lines and connectors in accordance with one or more embodiments of the present invention.

FIG. 5 shows a method of printing intersecting lines with angle effect in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

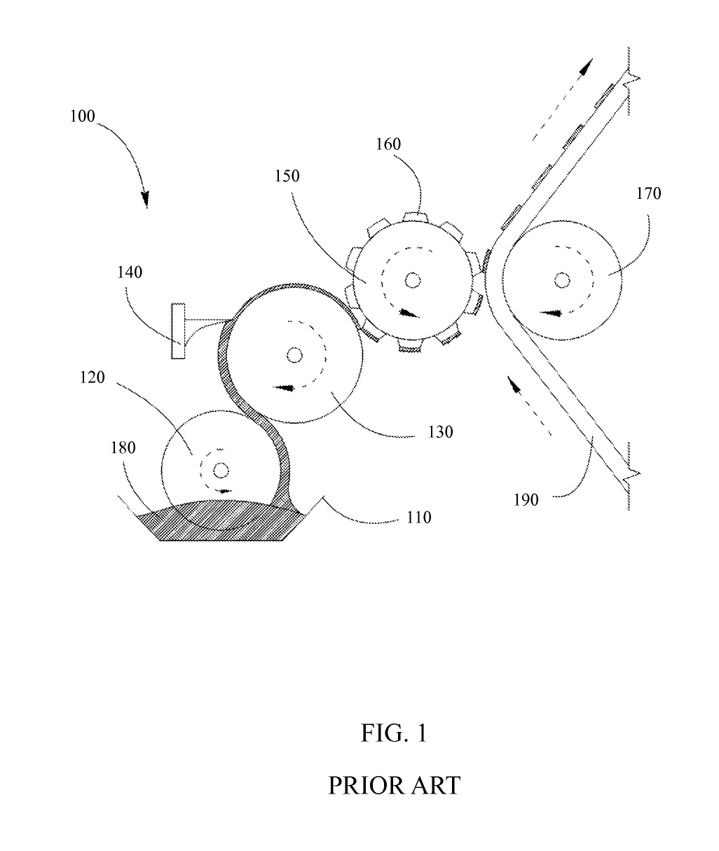

FIG. 1 shows a side view of a flexographic printing system. A conventional flexographic printing system 100 includes an ink pan 110, an ink roll 120 (also referred to as a fountain roll), an anilox roll 130 (also referred to as a meter roll), a doctor blade 140, a printing plate cylinder 150, a flexo master 160, and an impression cylinder 170.

Ink roll 120 transfers ink 180 from ink pan 120 to anilox roll 130. Ink 180 may be any suitable combination of monomers, oligomers, polymers, metal elements, metal element complexes, or organometallics in a liquid state. Anilox roll 130 is typically constructed of a steel or aluminum core that may be coated by an industrial ceramic whose surface contains a plurality of very fine dimples, known as cells (not shown). Doctor blade 140 removes excess of ink 180 from anilox roll 130. Anilox roll 130 meters the amount of ink 180 transferred to printing plate cylinder 150 to a uniform thickness. Printing plate cylinder 150 may be generally made of metal and the surface may be plated with chromium, or the like, to provide increased abrasion resistance. Flexo master 160 covers printing plate 150. Flexo master 160 may be a rubber or photo-polymer. A substrate 190 moves between the printing plate cylinder 150 and impression cylinder 170. Impression cylinder 170 applies pressure to printing plate cylinder 150, thereby transferring an image onto substrate 190. The rotational speed of printing plate cylinder 150 is synchronized to match the speed at which substrate 190 moves through the flexographic printing system 100. The speed may vary between 20 feet per minute to 2000 feet per minute.

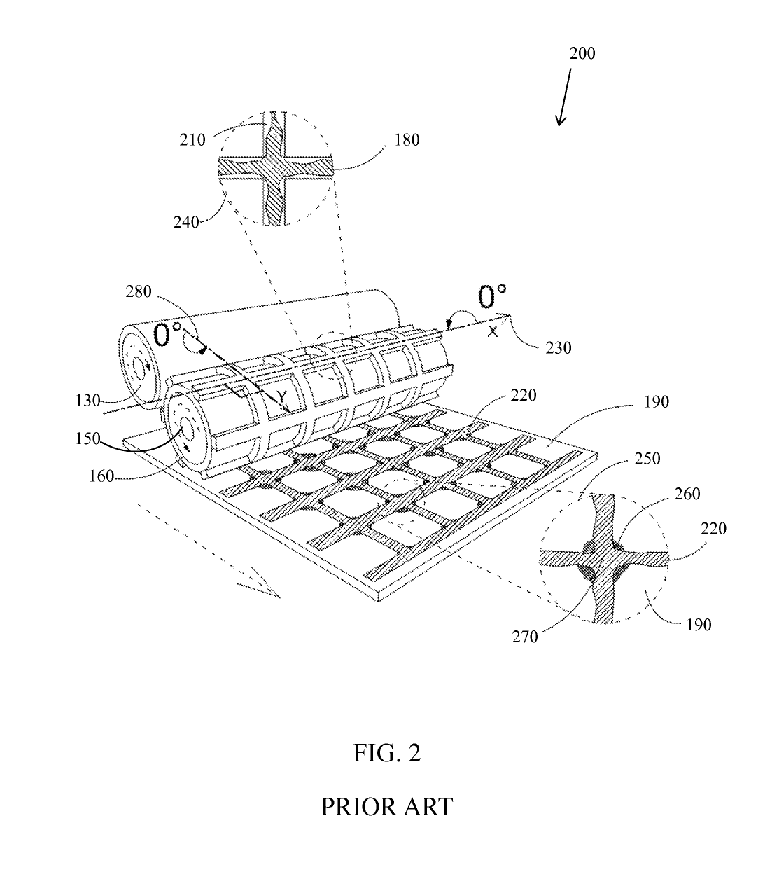

FIG. 2 shows an isometric view of a portion of a flexographic printing system. Flexo master 160 may include embossing patterns 210 that include lines that intersect each other to form a square grid. As anilox roll 130 rotates, ink 180 is transferred from anilox roll 130 to embossing patterns 210 of flexo master 160. As flexo master 160 rotates, embossing patterns 210 transfer ink 180 to substrate 190, forming high-resolution printed lines 220 in a machine and/or transverse direction in one pass. The alignment of embossing patterns 210 may be 0 degrees with respect to a x-y axis 230. Close-up view 240 shows a portion of embossing patterns 210 where ink 180 is inefficiently transferred from anilox roll 130 to embossing patterns 210. The inefficient transfer of ink 180 from anilox roll 130 may be the result of pixel-to-pixel configuration of embossing patterns 210 on flexo master 160. When embossing patterns 210 exhibit right angles, such as when embossing patterns 210 include lines that intersect each other to form a square grid, compression between anilox roll 130 and embossing patterns 210 may increase as well as contact area and time of contact. As a result, more ink 180 may be transferred from anilox roll 130 to embossing patterns 210 with a non-progressive distribution. Close-up view 250 shows a portion of high-resolution printed lines 220 on substrate 190 where a non-uniform transfer of ink 180 to substrate 190 may generate irregular line widths and heights along high-resolution printed lines 220, as well as accumulated ink 260 at printed intersection 270 on substrate 190. Because of the non-uniform transfer of ink 180 to substrate 190, the printed area that may be approximately three times wider with respect to the width of high-resolution printed lines 220.

For example, if high-resolution printed lines 220 exhibit a width of approximately 10 microns, printed intersection 270 may be approximately 30 microns wide, forming undesired visible patterns on a touch sensor as well as negatively affecting the electrical conductivity and capacitance of the conductors of the touch sensor. In addition, the amount of pressure applied towards pushing flexo master 160 into contact with substrate 190 may affect the amount of ink 180 transferred from embossing patterns 210 of flexo master 160 to substrate 190 and the amount of ink 180 transferred to the printed intersection 270. Because of sudden contact or compression between embossing patterns 210 and substrate 190, ink 180 is non-uniformly spread out at printed intersection 270 and accumulated ink 260 forms at printed intersections 270.

As such, a substantial limitation of flexographic printing systems is non-uniform line widths at printed intersections and accumulated ink at printed intersections.

In one or more embodiments of the present invention, a method of printing intersecting lines with angle effect allows for the printing of intersecting lines with uniform line width with substantially less accumulated ink at printed intersections.

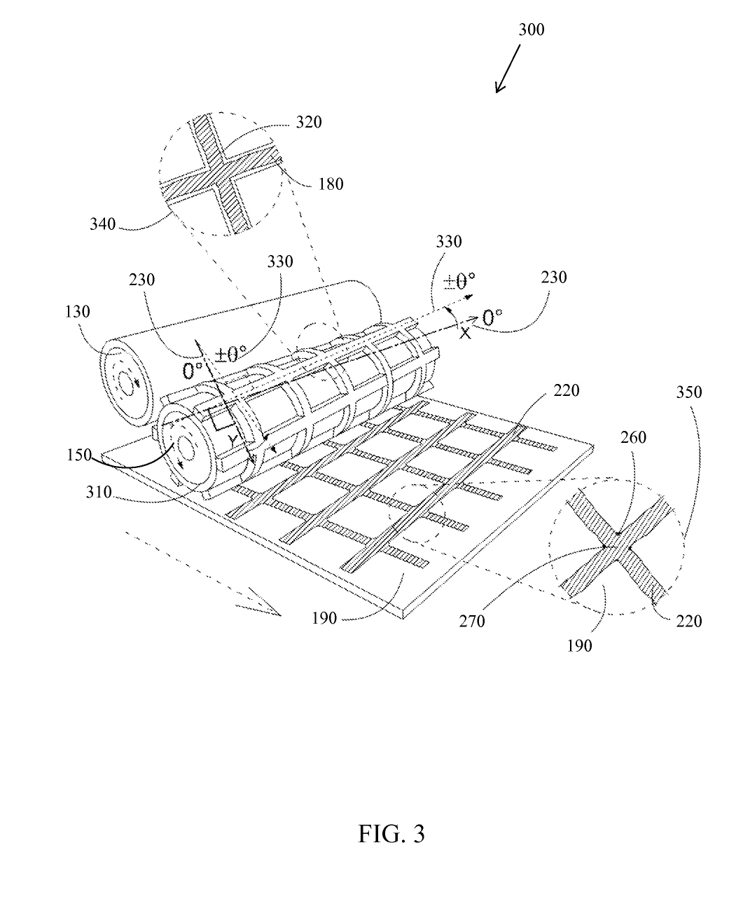

FIG. 3 shows an isometric view of a portion of a flexographic printing system for printing intersecting lines with angle effect in accordance with one or more embodiments of the present invention. Flexographic printing system 300 includes an ink pan (110 of FIG. 1), an ink roll (120 of FIG. 1), an anilox roll 130, a doctor blade (140 of FIG. 1), a printing plate cylinder (150 of FIG. 1), a flexo master 310, and an impression cylinder (170 of FIG. 1). Flexo master 310 includes embossing patterns 320 disposed at an adjusted angle relative to a directional printing axis.

Similar to FIG. 1, ink roll 120 transfers ink 180 from ink pan 110 to anilox roll 130. Anilox roll 130 may be constructed of a steel or aluminum core that may be coated by an industrial ceramic whose surface contains a plurality of very fine dimples, known as cells (not shown). Doctor blade 140 removes excess of ink 180 from anilox roll 130. Anilox roll 130 meters the amount of ink 180 transferred to printing plate cylinder 150 to a uniform thickness. Printing plate cylinder 150 may be made of metal and the surface may be plated with chromium, or the like, to provide increased abrasion resistance.

In one or more embodiments of the present invention, flexo master 310 covers printing plate cylinder 150. In one or more embodiments of the present invention, flexo master 310 may be a rubber or photo-polymer. Flexo master 310 includes embossing patterns 320 disposed at an adjusted angle 330 relative to x-y axis 230. In one or more embodiments of the present invention, embossing patterns 320 comprise a plurality of intersecting lines. In one or more embodiments of the present invention, embossing patterns 320 comprise a plurality of lines comprising at least one right angle. In one or more embodiments of the present invention, adjusted angle 330 may be approximately 20 degrees. In one or more embodiments of the present invention, adjusted angle 330 may be approximately 45 degrees. In one or more embodiments of the present invention, adjusted angle 330 may be in a range between approximately 20 degrees to approximately 45 degrees. In one or more embodiments of the present invention, adjusted angle 330 may be approximately −20 degrees. In one or more embodiments of the present invention, adjusted angle 330 may be approximately −45 degrees. In one or more embodiments of the present invention, adjusted angle 330 may be in a range between approximately −20 degrees to approximately −45 degrees.

Close-up view 340 shows a portion of embossing patterns 320 disposed at adjusted angle 330. In one or more embodiments of the present invention, because embossing patterns 320 are disposed at adjusted angle 330, ink 180 is transferred more uniformly from anilox roll 130 to embossing patterns 320. A substrate 190 moves between printing plate cylinder 150 and impression cylinder 170. Impression cylinder 170 applies pressure to printing plate cylinder 150, thereby transferring an image, ink 180 disposed on flexo master 310, onto substrate 190. The rotational speed of printing plate cylinder 150 is synchronized to match the speed at which substrate 190 moves through the flexographic printing system 300. The speed may vary between 20 feet per minute and 2000 feet per minute.

In one or more embodiments of the present invention, substrate 190 may be transparent. In one or more embodiments of the present invention, transparent means the transmission of light with a transmittance rate of 90% or more. In one or more embodiments of the present invention, the substrate may be opaque. In one or more embodiments of the present invention, substrate 190 may be polyethylene terephthalate (“PET”). In one or more embodiments of the present invention, substrate 190 may be polyethylene naphthalate (“PEN”). In one or more embodiments of the present invention, substrate 190 may be high-density polyethylene (“HDPE”). In one or more embodiments of the present invention, substrate 190 may be linear low-density polyethylene (“LLDPE”). In one or more embodiments of the present invention, substrate 190 may be bi-axially-oriented polypropylene (“BOPP”). In one or more embodiments of the present invention, substrate 190 may be a polyester substrate. In one or more embodiments of the present invention, substrate 190 may be a polypropylene substrate. In one or more embodiments of the present invention, substrate 190 may be a thin glass substrate. One of ordinary skill in the art will recognize that other substrates are within the scope of one or more embodiments of the present invention.

Close-up view 350 shows a portion of high-resolution printed lines 220 on substrate 190 with uniform line width. In one or more embodiments of the present invention, embossing patterns 320 disposed at an adjusted angle 330 may provide a more uniform distribution of compression between embossing patterns 320 and substrate 190. In one or more embodiments of the present invention, embossing patterns 320 disposed at an adjusted angle 330 may provide a more uniform distribution of ink 180 on substrate 190. In one or more embodiments of the present invention, embossing patterns 320 disposed at an adjusted angle 330 may provide a more uniform and consistent transfer of ink 180 to substrate 190. In one or more embodiments of the present invention, embossing patterns 320 disposed at an adjusted angle 330 may minimize line width variations across high-resolution printed lines 220 on substrate 190. In one or more embodiments of the present invention, embossing patterns 320 disposed at an adjusted angle 330 may minimize accumulated ink 260 at printed intersections 270.

In one or more embodiments of the present invention, embossing patterns 320 on flexo master 310 may be less than 10 microns in width. In one or more embodiments of the present invention, high-resolution printed lines 220 on substrate 190 may be less than 10 microns in width. In one or more embodiments of the present invention, embossing patterns 320 on flexo master 310 may have a width in a range between approximately 10 microns and approximately 50 microns. In one or more embodiments of the present invention, high-resolution printed lines 220 on substrate 190 may have a width in a range between approximately 10 microns and approximately 50 microns. In one or more embodiments of the present invention, embossing patterns 320 on flexo master 310 may have a width greater than 50 microns. In one or more embodiments of the present invention, high-resolution printed lines 220 on substrate 190 may have a width greater than 50 microns.

In one or more embodiments of the present invention, the reduction of accumulated ink 260 at printed intersections 270 may contribute to improved adhesion of high-resolution printed lines 220 to substrate 190, which may prevent peeling of high-resolution printed lines 220 after plating by an electroless plating process. In one or more embodiments of the present invention, high-resolution printed lines 220 may be conductive and suitable for plating by an electroless plating process. In one or more embodiments of the present invention, high-resolution printed lines 220 may be non-conductive.

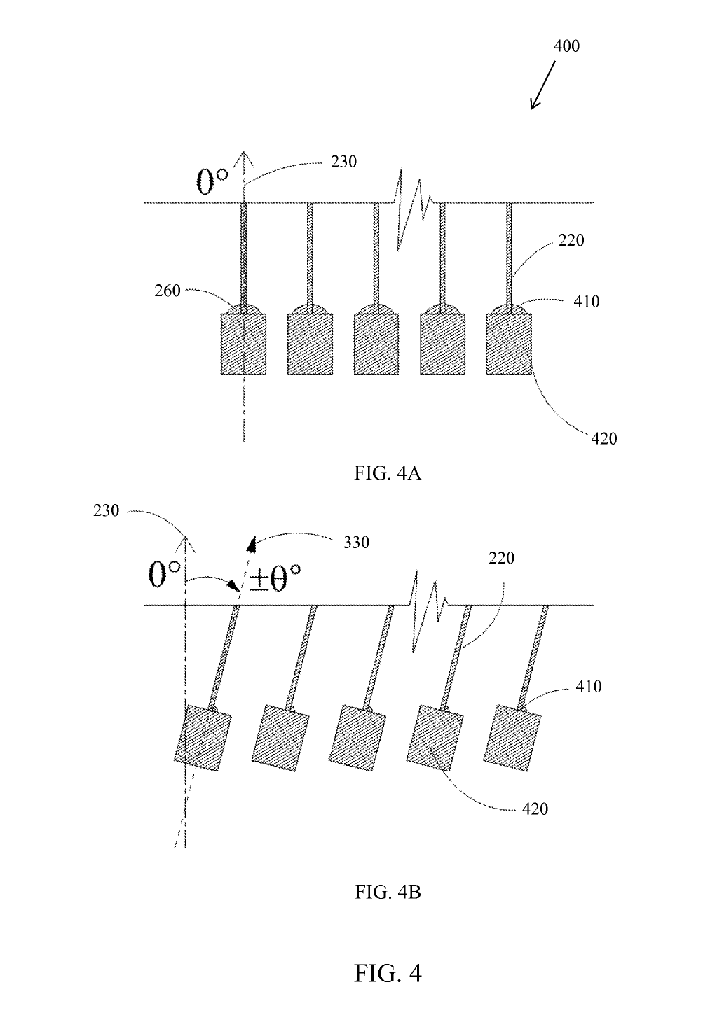

FIG. 4 shows a connection between high-resolution printed lines and connectors in accordance with one or more embodiments of the present invention. In FIG. 4A, a flexo master 160 with embossing patterns 240 are disposed at a 0 degree angle with respect to an x-y axis 230. High-resolution printed lines 220 formed on substrate 190 may be routed to printed connectors 420 that may be used in a touch sensor. Ink 180 may accumulate 260 at printed connection 410 between high-resolution printed lines 220 and printed connectors 420. This accumulated ink 260 may be visible in a touch sensor. In FIG. 4B, a flexo master 310 with embossing patterns 340 disposed at an adjusted angle 330 with respect to an x-y axis 230. In one or more embodiments of the present invention, embossing patterns 340 disposed at an adjusted angle 330 substantially reduces the amount of accumulated ink 260 at printed connection 410 between high-resolution printed lines 220 and printed connectors 420.

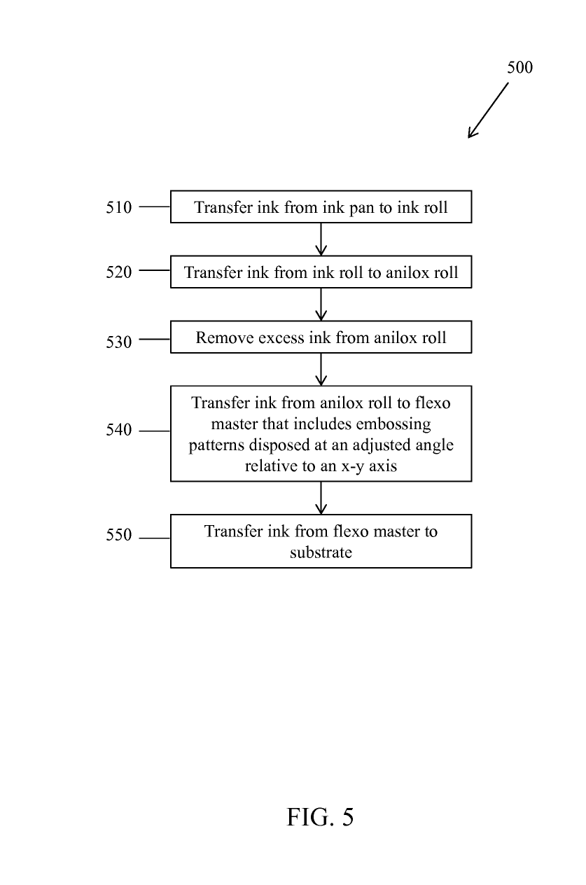

FIG. 5 shows a method of printing intersecting lines with angle effect in accordance with one or more embodiments of the present invention. In step 510, ink is transferred from an ink pan to an ink roll. In one or more embodiments of the present invention, the ink may be conductive and suitable for plating by an electroless plating process. In one or more embodiments of the present invention, the ink may be non-conductive. In step 520, ink is transferred from the ink roll to an anilox roll. In step 530, excess ink is removed from the anilox roll with a doctor blade. In step 540, ink is transferred from the anilox roll to a flexo master that includes embossing patterns disposed at an adjusted angle relative to an x-y axis.

In one or more embodiments of the present invention, the embossing patterns comprise a plurality of intersecting lines. In one or more embodiments of the present invention, the embossing patterns comprise a plurality of lines comprising at least one right angle. In one or more embodiments of the present invention, the embossing patterns comprise a plurality of intersecting lines with a line width less than approximately 10 microns. In one or more embodiments of the present invention, the adjusted angle may be in a range between approximately 20 degrees to approximately 45 degrees relative to the x-y axis. In one or more embodiments of the present invention, the adjusted angle may be in a range between approximately −20 degrees to approximately −45 degrees relative to the x-y axis.

The flexo master is disposed on a plate cylinder. In step 550, ink is transferred from the flexo master to a substrate. In one or more embodiments of the present invention, the substrate may be transparent. In one or more embodiments of the present invention, the substrate may be opaque. In one or more embodiments of the present invention, the substrate may be PET, PEN, HDPE, LLDPE, BOPP, a polyester substrate, a polypropylene substrate, or a thin glass substrate. One of ordinary skill in the art will recognize that other substrates are within the scope of one or more embodiments of the present invention. The substrate is movably disposed between the flexo master and an impression cylinder. The impression cylinder applies pressure to a point of contact between the flexo master and the substrate.

Advantages of one or more embodiments of the present invention may include one or more of the following:

In one or more embodiments of the present invention, a method of printing intersecting lines with angle effect allows for the printing of intersecting lines with uniform line widths.

In one or more embodiments of the present invention, a method of printing intersecting lines with angle effect allows for the printing of intersecting lines with uniform line widths with line widths less than 10 microns.

In one or more embodiments of the present invention, a method of printing intersecting lines with angle effect allows for the printing of intersecting lines with substantially less accumulated ink at printed intersections.

In one or more embodiments of the present invention, a method of printing intersecting lines with angle effect provides a more uniform distribution of compression between embossing patterns and substrate.

In one or more embodiments of the present invention, a method of printing intersecting lines with angle effect provides a more uniform distribution of ink on substrate.

In one or more embodiments of the present invention, a method of printing intersecting lines with angle effect provides a more consistent transfer of ink to substrate.

In one or more embodiments of the present invention, a method of printing intersecting lines with angle effect minimizes line width variations across high-resolution printed lines on substrate.

In one or more embodiments of the present invention, a method of printing intersecting lines with angle effect minimizes accumulated ink at printed intersections.

In one or more embodiments of the present invention, the reduction of accumulated ink at printed intersections may contribute to improved adhesion of high-resolution printed lines to substrate, which may prevent peeling of high-resolution printed lines after plating by an electroless plating process.

In one or more embodiments of the present invention, a method of printing intersecting lines with angle effect allows for the fabrication of touch sensors with smaller line widths.

In one or more embodiments of the present invention, a method of printing intersecting lines with angle effect allows for the fabrication of touch sensors with improved transparency.

In one or more embodiments of the present invention, a method of printing intersecting lines with angle effect allows for the fabrication of touch sensors with improved transparency.

In one or more embodiments of the present invention, a method of printing intersecting lines with angle effect allows for the fabrication of touch sensors with improved electrical conductivity and capacitance.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of printing intersecting lines with angle effect comprising:
transferring ink to a flexo master comprising embossing patterns disposed at an adjusted angle relative to an x-y axis; and
transferring ink from the flexo master to a substrate.

2. The method of claim 1, further comprising:
transferring ink from an ink pan to an ink roll;
transferring ink from the ink roll to an anilox roll; and
removing excess ink from the anilox roll.

3. The method of claim 1, wherein the embossing patterns comprise a plurality of intersecting lines.

4. The method of claim 1, wherein the adjusted angle is in a range between approximately 20 degrees and approximately 45 degrees.

5. The method of claim 1, wherein the adjusted angle is in a range between approximately −20 degrees and approximately −45 degrees.

6. The method of claim 2, wherein the ink is transferred to the flexo master from the anilox roll.

7. The method of claim 1, wherein the flexo master is disposed on a plate cylinder.

8. The method of claim 1, wherein the substrate is movably disposed between the flexo master and an impression cylinder.

9. The method of claim 8, wherein the impression cylinder applies pressure to a point of contact between the flexo master and the substrate.

10. The method of claim 3, wherein the plurality of embossing patterns comprise intersecting lines with a line width less than approximately 10 microns.

11. The method of claim 3, wherein the plurality of embossing patterns comprise intersecting lines with a line width in a range between approximately 10 microns and approximately 50 microns.

12. The method of claim 3, wherein the plurality of embossing patterns comprise intersecting lines with a line width greater than 50 microns.

13. A flexographic printing system comprising:
an ink roll;
an anilox roll;
a plate cylinder;
a flexo master disposed on the plate cylinder, wherein the flexo master comprises embossing patterns disposed at an adjusted angle relative to an x-y axis; and
an impression cylinder.

14. The flexographic printing system of claim 13, further comprising:
an ink pan; and
a doctor blade.

15. The flexographic printing system of claim 13, wherein the embossing patterns comprise a plurality of intersecting lines.

16. The flexographic printing system of claim 13, wherein the adjusted angle is in a range between approximately 20 degrees and approximately 45 degrees.

17. The flexographic printing system of claim 13, wherein the adjusted angle is in a range between approximately −20 degrees and approximately −45 degrees.

18. The flexographic printing system of claim 13, wherein the ink is transferred to the flexo master from the anilox roll.

19. The flexographic printing system of claim 13, wherein the flexo master is disposed on the plate cylinder.

20. The flexographic printing system of claim 13, wherein the substrate is movably disposed between the flexo master and an impression cylinder.

21. The flexographic printing system of claim 20, wherein the impression cylinder applies pressure to a point of contact between the flexo master and the substrate.

22. The flexographic printing system of claim 13, wherein the embossing patterns comprise intersecting lines with a line width less than approximately 10 microns.

23. The flexographic printing system of claim 13, wherein the embossing patterns comprise intersecting lines with a line width in a range between approximately 10 microns and approximately 50 microns.

24. The flexographic printing system of claim 13, wherein the embossing patterns comprise intersecting lines with a line width greater than 50 microns.
